(19) United States
(12) Patent Application Publication
(10) Pub. No.: US 2009/0103694 A1
(43) Pub. Date: Apr. 23, 2009

(54) APPARATUS, SYSTEM, AND METHOD FOR DELIVERING VOICE COMMUNICATIONS

(75) Inventors: David H. Liu, Herndon, VA (US); Guy M. Merritt, Purcellville, VA (US); Fung-Chang Huang, Herndon, VA (US); Marc R. Bernard, Miramar, FL (US)

Correspondence Address: FITZPATRICK CELLA HARPER & SCINTO, 30 ROCKEFELLER PLAZA, NEW YORK, NY, 10112, US

(73) Assignee: TELLABS VIENNA, INC., Naperville, IL (US)

(21) Appl. No.: 11/873,549

(22) Filed: Oct. 17, 2007

(51) Int. Cl. H04M 11/00

(52) U.S. Cl. 379/90.01

(57) ABSTRACT

A network element, a system to deliver voice communications, and methods for delivering voice services from an optical network to a telephone at a location within a premises. The system may include a network element and a telephone system having a connector. The telephone system may be positioned proximate to the network element so that the connector contacts an analog interface of the network element.

### BACKGROUND

1. Field

Disclosed herein are an apparatus, system, and method that may be used to provide voice communications. More specifically, in example embodiments of the invention described herein, an optical network element is connected to a telephone positioned proximate to the optical network element so as to provide voice communications from a network to a user.

2. Description of the Related Art

There is a growing demand in the industry to find ways to transmit voice, data, and video from a headend to a subscriber's premises through a fiber optic network all the way to an individual home or business. Such fiber optic networks generally are referred to as fiber-to-the-home (FTTH), fiber-to-the premises (FTTP), fiber-to-the-business (FTTB), fiber-to-the-node (FTTN), or fiber-to-the-curb (FTTC) networks and the like, depending on the specific application of interest. Such types of networks are referred to herein as “FTTx networks.”

In an FTTx network, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into analog signals using an Optical Network Terminal (ONT). The ONT may split the resultant signals into separate services required by the subscriber such as computer networking (data), telephony and video. In many cases, the ONT is provided outside a building structure at the premises, with analog signals being used to carry the services to various devices within the building.

In order to provide telephony services, an RJ11 port is often provided on the ONT. Standard telephone wiring, such as copper phone lines, can be connected to the RJ11 port. The telephone wiring may then be extended to another location away from the ONT, where the wiring is operatively connected to a telephone. Thus, analog signals carrying voice communications may be routed from the ONT to a telephone handset for receipt by a user.

In general, optical signals are extremely difficult to intercept or eavesdrop upon. On the other hand, analog signals, such as those traveling through copper phone lines, are a comparatively easy target for intruders to intercept and monitor. Thus, while the optical signals carrying voice communications from an optical network, such as an FTTx network, to an ONT are secure, the analog signals from the ONT to the telephone are a potential target for someone wishing to intrude or monitor the voice communications.

### SUMMARY

Example embodiments of the invention provide various apparatuses, systems, and method for delivering voice communications.

In one example embodiment of the invention a network element is provided. The network element comprises an analog interface and a telephone with a connection element. The telephone is positioned proximate to the analog interface and the connection element of the telephone is connected to the analog interface.

In another example embodiment of the invention a system to deliver voice communications is disclosed. The system includes a network element and telephone system having a connector. The telephone system is positioned proximate to the optical network element and the connector contacts an analog interface of the optical network element.

In a further example embodiment of the invention a method of providing voice communications from an optical network is disclosed. The method comprises routing optical signals that carry the voice communications to an optical network element, converting the optical signals into analog signals at the optical network element, and routing the analog signals to a telephone integrated with the optical network element.

In a still further example embodiment of the invention a method of delivering voice services from an optical network to a telephone at a location within a premises is disclosed. The method comprises routing optical signals that carry voice communications to an optical network terminal at the location within the premises, converting the optical signals into analog signals in the optical network terminal, and routing the analog signals to a telephone integrated with the optical network terminal.

### BRIEF DESCRIPTION OF THE DRAWINGS

FIG. 1 is block diagram of components of an optical network system according to an example embodiment of the invention.

FIG. 2 is an optical network terminal that may be used as an optical network element according to example embodiments of the invention.

FIG. 3 is a telephone module for use as part of an optical network element according to example embodiments of the invention.

FIG. 4 shows the connection between a telephone module and an optical network terminal according to an example embodiment of the invention.

FIG. 5 shows an optical network terminal that includes a telephone module according to an example embodiment of the invention.

FIG. 6 shows an optical network terminal with an integral telephone according to example embodiments of the invention.

FIG. 7 is a flow chart showing a method according to an example embodiment of the invention.

FIG. 8 is an architecture diagram for an example data processing system that may be a part of a network element according to example aspects of the invention.

### DETAILED DESCRIPTION

As will be described more fully below, according to example aspects and example embodiments of the invention, a network element, such as an optical network terminal (ONT), is integrated with a telephone or telephone module. As a result, voice transmissions being sent to the network element may be delivered from the network element to a telephone, without using analog signals over extended telephone phone lines. Instead, the voice transmission may be delivered from the network element directly to the telephone, which is positioned proximate to the network element. In further example aspects and embodiments, the network element may be an optical network element, such as an optical network terminal (ONT), which is used in conjunction with a fiber optic network.

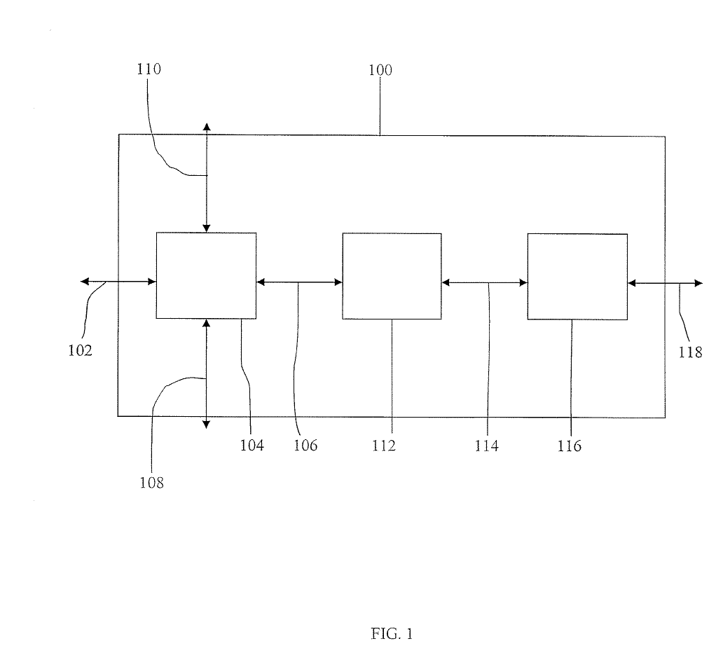

FIG. 1 is a block diagram of components of an optical network system according to an example embodiment of the invention. In this example embodiment, the optical network system includes an optical network element 100. The optical network element 100 may be, for example, an optical network terminal (ONT). However, the optical network element 100 may be other components operative with an optical network, such as a remote terminal (RT), a network terminal (NT), an optical line terminal (OLT), and the like.

The optical network element receives optical signals 102 from an external source. In example embodiments of the invention, the external source may be a fiber optic network. In more specific example embodiments, the fiber optic network may be an FTTx network. Moreover, the fiber optic network may support a variety of network architectures, such as a passive optical network (PON), Broadband PON (BPON), a Gigabit PON (GPON), and the like. Other types of network architectures may be used as well.

The optical signals 102 may carry a variety of data, video, and voice transmissions, using a variety of different protocols. For example, in some example embodiments, the voice transmissions may be carried according to Voice over Internet Protocol (VoIP). Other types of protocols for transmitting the voice transmissions can be used as well.

The optical signals 102 are received at element 104 of the optical network element 100. Although shown as a single block in FIG. 1, the element 104 may actually include a plurality of elements, such as a transceiver, wave dimension multiplexer/demultiplexer, a media access controller (MAC), an integrated access device (IAD), and other elements that may operate within an optical network element.

In example embodiments of the invention, the element 104 includes an optical-to-electrical converter, so as to transform the optical signals 102 into analog signals. As noted above, a variety of voice, data, and/or video transmissions may be included in the optical signals 102 routed to the optical network element 100. Accordingly, the element 104 may include further components that separate and route the analog signals 106, 108, and 110 converted from the optical signals 102 to further elements of the optical network element 100, and ultimately to devices outside the optical network element 100 used for the specific services being provided. In the example embodiment shown in FIG. 1, the analog signals 108 and 110 may carry data and/or video transmissions to other unshown parts of the optical network element 100, whereas analog signals 106 may be used to carry voice transmissions. It should be noted that any number of separate analog signals for providing any number of services may be associated with optical network element 100, depending on the particular configuration being used.

FIG. 8 is an architecture diagram for an example data processing system 800, which, according to example embodiments, can form individual ones of the components of the optical network element 100. Data processing system 800 includes a processor 802 coupled to a memory 804 via system bus 806. Processor 802 is also coupled to external Input/Output (I/O) devices (not shown) via the system bus 806 and an I/O bus 808, and at least one input/output user interface 818. Processor 802 may be further coupled to a communications device 814 via a communications device controller 816 coupled to the I/O bus 808. Processor 802 uses the communications device 814 to communicate with a network, such as, for example, an FTTx network, and the device 814 may have one or more input and output ports. Processor 802 also can include an internal clock (not shown) to keep track of time, periodic time intervals, and the like.

Referring again to FIG. 1, the analog signals 106 may be routed to an analog interface 112. In example embodiments of the invention, the analog interface 112 may be a subscriber line interface circuit (SLIC). In further example embodiments of the invention, the interface 112 may include an RJ11 port. Voice transmission signals 114 may be routed through the interface 112 to a telephone 116. Further, the telephone 116 may include elements that ultimately deliver the voice signals 118 to a user, as will be more fully described below. It should be noted that although while example embodiments of the invention herein will be described as including a “telephone” or a “telephone module,” one of ordinary skill in the art will recognize that a variety communication devices could alternatively be used in place of the telephone element. For example, any communication device that is capable of receiving analog signals may be used in association with the optical network element.

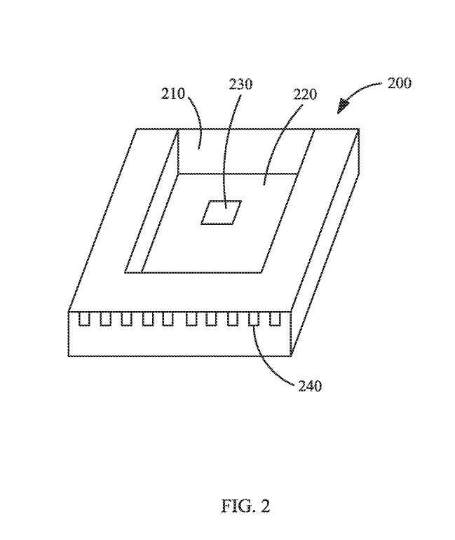

FIG. 2 is a diagram of an optical network terminal (ONT) 200 that may be used as part of an optical network element in example embodiments of the invention. The ONT 200 includes an open slot 210 on an upper surface of its body. A surface 220 of the slot 210 includes an opening 230 that allows access to an analog interface contained within the ONT 200. The slot 210 can be used to receive a telephone module, with the telephone module being connected to the analog interface through the opening 230, as will be described more fully below.

It should be noted that the general shape of the ONT 200, as well as the general spatial relation of its features, could be in a variety of forms other than those specifically depicted in FIG. 2. For example, the slot 210 could be provided on any of the surfaces of ONT 200. Moreover, the opening 230 in the slot 210 could be provided on any of the surfaces of the slot 210, or, alternatively, on any of the other surfaces of the ONT 200. Still further, the ONT 200 may include additional elements associated with its external surfaces. In this regard, in the example embodiment of FIG. 2, the ONT 200 includes LEDs 240 on its external surface that may be used to indicate various states and processes being performed by the ONT 200.

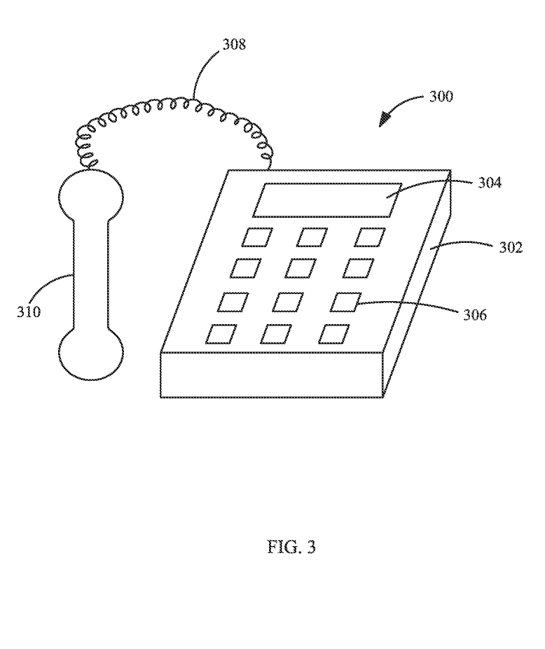

FIG. 3 shows a telephone module 300 that may be used in conjunction with, or as a part of, an optical network element in example embodiments of the invention. The telephone module 300 includes a main body portion 302 that contains telephone circuitry. In example embodiments of the invention, the circuitry within the main body portion 302 can be a plain old telephone system (POTS).

The main body portion 302 of telephone module 300 also includes a dial pad 306 and display 304 for operating the telephone module. The dial pad 306 may include buttons for dialing numbers, switching between separate phone lines, accessing a voice mail service, etc., as with any known telephone device. The display 304 may provide an indication of a number being dialed, caller ID of an incoming call, a voice message, etc., as with any known telephone device. In this regard, the telephone may have any number of buttons, displays, and lights, and is not generally limited to any particular configuration, such as that depicted in FIG. 3.

One feature that telephone module 300 may have in example embodiments of the invention is a specific button or buttons for changing the “hook state” of the telephone. That is, a button or buttons may be provided to allow the user to toggle between a state wherein the telephone is being operated by a user (“off the hook”) and a state wherein the telephone is not being operated by a user and is ready to receive calls (“on the hook”).

The main body portion 302 of telephone module 300 may further be connected to a handset 310 using a cord 308. The cord 300 may be, for example, a standard cord which interfaces through a port (unshown) with the main body portion 302 as in conventional telephones. The cord 308 may thereby deliver the voice transmissions to the handset 310, wherein the transmissions are converted to audible sounds for receipt by a user of the telephone.

In alternative example embodiments of the invention, the main body portion 300 may be operatively connected to a cordless handset. In such example embodiments, standard cordless telephone mechanisms may be used to communicate between the main body portion and the handset.

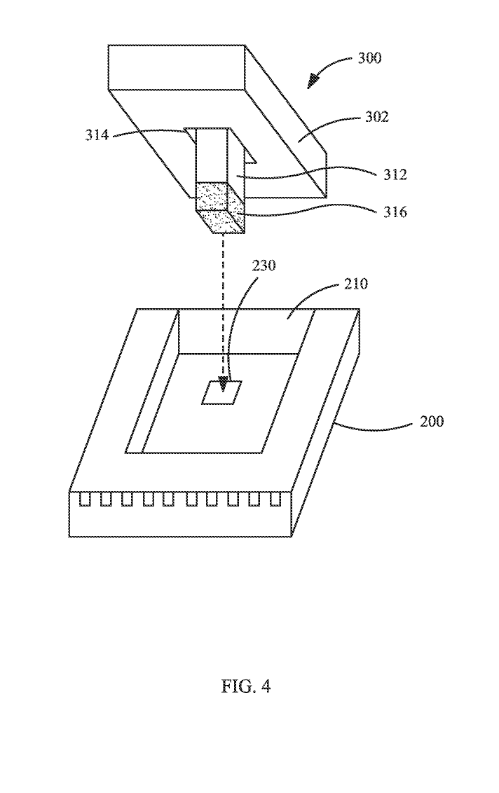

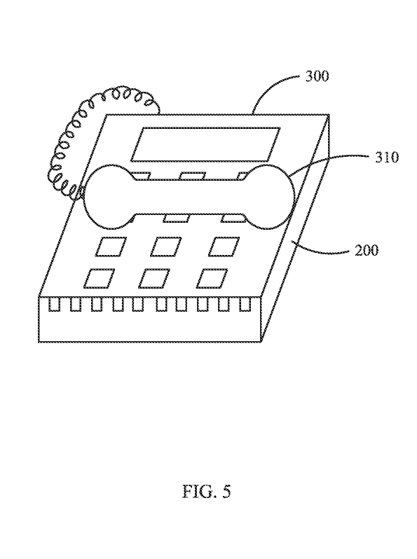

FIGS. 4 and 5 show the association between the ONT 200 and telephone module 300. The telephone module 300 includes a connection element 312 that is connected at one end to the phone circuitry provided within the main body portion 302. The connection element 312 extends through an opening 314 on the underside of the telephone module 300. As the telephone module 300 is positioned proximate to slot 210, the connection element 312 may be placed through opening 230 in the ONT 200. The end of the connection element 312 includes an adaptor 314 which may be connected to the analog interface inside the ONT 200. Thus, the telephone module 300 may be operatively connected to the ONT 200 so as to receive the analog signals carrying voice transmissions.

It should be noted that the term “proximate” as used herein, is intended to convey a “closeness,” which may be synonymous with different terms, such as “touching,” “adjacent,” “nearby,” “adjoining,” “in contact,” “contiguous,” etc. In the context of the example embodiments shown in FIGS. 4 and 5, the telephone module 300 is “proximate” to the ONT 200, as differentiated from past configurations wherein a copper phone line was extended from an ONT to a telephone at a location remote from the ONT.

It should be noted that although the opening 314 and connection element 312 are depicted in FIG. 4 on the underside of the telephone module 300, the opening 314 and connection element 312 could be placed on other surfaces of the telephone module 300. Correspondingly, the opening 230 in the optical network terminal 200 may be placed on other surfaces of the slot 210 so as to be proximate to the opening 314 and connection element 312 when the telephone module 300 is inserted into the slot 210. Further, the connection element 312 could be extended in length so as to reach opening 230 in example embodiments of the invention wherein the opening 314 and opening 230 are not immediately adjacent to each other.

As shown in FIG. 5, telephone module 300 may be received in slot 210 so as to be substantially surrounded by the ONT 200. In such a case, none of the elements allowing for the connection between the telephone module 300 and the ONT 200 are exposed outside the proximal area of ONT 200 and telephone module 300. As generally described above, in example embodiments of the invention the connection element 312 may be a tip and ring, and opening 230 may be associated with an RJ11 port operating with the analog interface within ONT 200. In such a case, the RJ11 port is covered as the telephone module 300 is inserted into slot 210, and, thus, not exposed to the outside of the proximal area of ONT 200 and telephone module 300.

It should be noted that although FIGS. 4 and 5 depict the telephone module 300 as being substantially received in a slot on the top surface of the ONT 200, the telephone module 300 may be associated with other surfaces of the ONT 200. For example, the telephone module 300 may be placed on a side surface of the ONT 200. In such a case, the slot 210 and opening 230 may be located on the side surface so as to substantially receive the telephone module 300. Moreover, in still further example embodiments of the invention, the ONT 200 may not include a slot 210 for receiving the telephone module 300. In such example embodiments, the opening 230 may be located on a surface of the ONT 200, and the telephone module may be place at a position proximate to the ONT 200 so as to allow the connection element to reach opening 230. In these example embodiments, the telephone module 300 may still cover the opening 230, thereby preventing any of the connection elements from being exposed to outside of the proximal area of ONT 200 and telephone module 300.

FIG. 6 shows another example embodiment of the invention. In this example embodiment, ONT 400 includes an integral telephone element 402, instead of a separate telephone module. The telephone circuitry is provided inside of the ONT 400, and operatively connected to the functional elements of the ONT 400. As with the previously described example embodiments, no elements of the connection between the telephone element 402 and the ONT 200 are exposed outside the ONT 200.

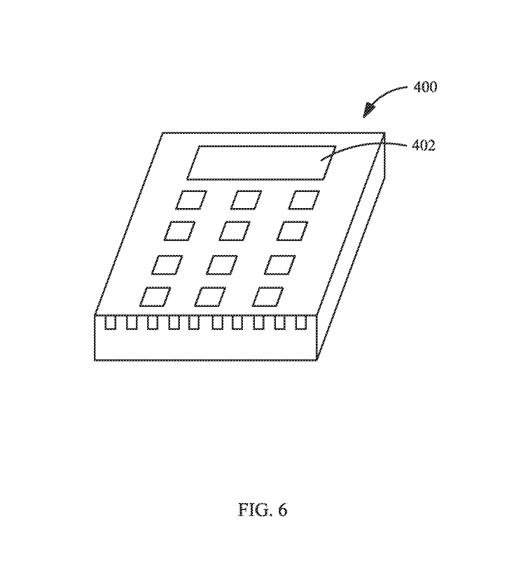

FIG. 7 is a flow chart showing features of a method according to an example embodiment of the invention. In block 710, optical signals that include voice transmissions are routed from a fiber optic network to a premises. The “premises” may be a variety of places, such as a business, a home, and the like. In block 720, the optical signals are routed to a location inside the building structure defining the premises. In more specific example embodiments of the invention, the location may be a desktop. The optical signals are routed at the location to an optical network element in block 730. The optical network element may be configured as described above. In block 740, the optical signals are converted at the location optical network element to analog signals. The analog signals are then routed to a telephone proximate to the optical network element at block 750. Thus, the voice transmission which has been carried by the optical signals and the analog signals may be received by a user operating the telephone.

In the example embodiments described above, optical signals may be carried all the way to an optical network element positioned at a location within a premises, such as a desktop. Thus, because optical signals are difficult to intercept or monitor, a secure connection all the way to the optical network element at the desktop is established. Further, as in the example embodiments described above, because of the proximate positioning of the telephone and optical network element, the connection elements are unexposed outside the proximal area of the telephone and optical network element association. Thus, potential unsecure targets, such as extended copper phone lines, for persons attempting to intercept or monitor the voice transmissions being used with the system are eliminated.

Although the example aspects of the invention have been described in certain specific example embodiments, many additional modifications and variations would be apparent to those skilled in the art. It is therefore to be understood that the example aspects of the invention may be practiced otherwise than as specifically described. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the example embodiments of the invention. Thus, the present example embodiments of the invention should be considered in all respects as illustrative and not restrictive, with the scope to be determined by any claims supportable by this application and the claims' equivalents rather than the foregoing description.

In addition, it should be understood that the figures illustrated in the attachments, which highlight the functionality and usefulness of the disclosed apparatuses, methods, and systems, are presented for example purposes only. The architectures are sufficiently flexible and configurable, such that it may be utilized (and navigated) in ways other than that shown in the accompanying figures.

Furthermore, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting in any way. It is also to be understood that the processes recited in the claims need not be performed in the order presented.

What is claimed is:

1. An network element, comprising:
an analog interface; and
a telephone with a connection element,
wherein the telephone is positioned proximate to the analog interface, and
wherein the connection element of the telephone is connected to the analog interface.

2. A network element as set forth in claim 1, further comprising an interface for receiving optical signals.

3. A network element as set forth in claim 1, wherein the network element includes an optical network terminal.

4. A network element as set forth in claim 3, wherein the optical network terminal has a slot, and the telephone is positioned in the slot so that the optical network terminal substantially surrounds the telephone.

5. A network element as set forth in claim 1, wherein the analog interface includes a subscriber line interface circuit.

6. A network element as set forth in claim 3, wherein the connection element is a tip and ring, with one end of the tip and ring associated with the telephone, and the other end of the tip and ring associated with the analog interface.

7. A network element as set forth in claim 6, wherein the tip and ring are provided on an underside of the telephone.

8. An optical network element as set forth in claim 7, wherein the optical network terminal has a slot, and the telephone is positioned in the slot so that the optical network terminal substantially surrounds the telephone.

9. An optical network element as set forth in claim 8, wherein the slot includes an opening that allows access to the analog interface, and the tip and ring is positioned in the opening.

10. An optical network element as set forth in claim 1, wherein the telephone is an integral with the network element.

11. A system to deliver voice communications, comprising:
a network element; and
a telephone system having a connector,
wherein the telephone system is positioned proximate to the network element and the connector contacts an analog interface of the network element.

12. A system as set forth in claim 11, wherein the network element is an optical network element.

13. A system as set forth in claim 12, wherein the optical network element is an optical network terminal.

14. A system as set forth in claim 12, wherein the optical network element and the telephone system are an integral unit.

15. A system as set forth in claim 12, wherein the telephone system includes a module which is associated with the optical network element, with the module being positioned in a slot in the optical network element.

16. A system as set forth in claim 11, wherein the connector is a tip and ring of the telephone system that contacts the analog interface of the network element.

17. A system as set forth in claim 11, wherein the analog interface includes a subscriber line interface circuit.

18. A method of providing voice communications from an optical network, comprising:
routing optical signals that carry the voice communications to an optical network element;
converting the optical signals into analog signals at the optical network element;
routing the analog signals to a telephone integrated with the optical network element.

19. A method as set forth in claim 18, wherein none of connection elements between the optical network element and the telephone are exposed outside a proximal area of the optical network element and the telephone.

20. A method as set forth in claim 18, wherein the telephone includes a module which is in contact with the optical network element.

21. A method of delivering voice services from an optical network to a telephone at a location within a premises, comprising
routing optical signals that carry voice communications to an optical network terminal at the location within the premises;
converting the optical signals into analog signals in the optical network terminal;
routing the analog signals to a telephone integrated with the optical network terminal.

22. A method as set forth in claim 21, wherein none of connection elements between the optical network element and the telephone are exposed outside the proximal area of the optical network element and the telephone.

23. A method as set forth in claim 21, wherein the telephone includes a module which is in contact with the optical network element.

24. A network element as set forth in claim 1, wherein no copper telephone lines are exposed outside a proximal area of the analog interface and telephone.

25. A system as set forth in claim 11, wherein no copper telephone lines are exposed outside a proximal area of the network element and telephone system.
